(19) United States
(12) Patent Application Publication
(10) Pub. No.: US 2017/0170926 A1
(43) Pub. Date: Jun. 15, 2017

(54) Transmission Arrangement Provided With a First Mobile Transmitter and a Second Mobile Transmitter, and First Mobile Transmitter and Second Mobile Transmitter Which can be Used in the Transmission Arrangement

(71) Applicant: INSTITUT FUR RUNDFUNKTECHNIK GMBH, Munchen (DE)

(72) Inventors: Mathias Laabs, Munchen (DE); Andreas Metz, Munchen (DE)

(73) Assignee: INSTITUT FUR RUNDFUNKTECHNIK GMBH, Munchen (DE)

(21) Appl. No.: 15/117,110

(22) PCT Filed: Feb. 6, 2015
(86) PCT No.: PCT/EP2015/052562

§ 371 Date: Aug. 5, 2016

(30) Foreign Application Priority Data
Feb. 7, 2014 (IT) TO2014A000102

(51) Int. Cl. H04L 1/00

(52) U.S. Cl. CPC H04L 1/0057; H04L 1/0076; H04L 1/0041; H04L 1/0045

(57) ABSTRACT

A transmission arrangement is provided with a first and a second mobile transmitter for transmitting an information signal to a receiver. The first transmitter is adapted to store subsequent blocks of the information signal in subsequent IP (Internet Protocol) information blocks (IPB) and to transmit the IP information blocks as first information signal via an IP transmission path to the receiver. Furthermore, the first transmitter is adapted to transmit a second information signal derived from the first mentioned information signal in subsequent information blocks as a second transmission signal via a second transmission path to the second transmitter. The second transmitter is adapted to derive an error correction signal from the second transmission signal and to transmit the error correction signal in IP information blocks as a third transmission signal via a third transmission path to the receiver. At least the second mobile transmitter includes a smartphone operating system. Deriving the error correction signal in the second transmitter can be realized by already converting the information signal in the first transmitter into an error correction signal, and the second transmitter merely derives the error correction signal from the second transmission signal.

### BACKGROUND OF THE INVENTION

The invention refers to a transmission arrangement according to the prior art portion of claim 1, to a first mobile transmitter according to claim 12, and to a second mobile transmitter according to claim 21, which mobile transmitters can be used in the transmission arrangement.

A transmission arrangement according to the preamble of claim 1 is known as an ordinary mobile phone transmission system, whereby a mobile phone interacts with a receiver for transmitting phone calls. However, the invention is not limited to mobile phones. More general, it is about transmitters comprising a smartphone operating system, such as e.g. tablets.

### BRIEF DESCRIPTION OF THE INVENTION

Object of the invention is to expand the transmission arrangement in a way that it is suitable for e.g. reporter purposes, the known transmission arrangement has the disadvantage, that it is not suitable for reporter purposes. However, to make this possible, the known transmission arrangement is further characterized according to the features of claim 1. The first transmitter is characterized according to claim 12 and the second mobile transmitter is characterized according to claim 21. Preferred exemplary embodiments of the transmission arrangement and the transmitters are characterized by the dependent claims.

The invention is based on the following inventive idea.

Until now, the transmission arrangement transmits the signals only via one way. For reportage purposes, in particular for live broadcasting, it is important to transmit the signals without errors.

The invention is intended to realize a robust mobile transmission by means of 100 percent 2-way-redundance with off-the-shelf hardware, namely two mobile transmitters, such as e.g. smartphones and an app for recording. The app for transmitting, the usability and the operation method of the reporter and of the receiver remains unrevised. By means of the separated/redundant transmission connections, a flawless IP transmission can be ensured, even at a (not uninterruptible) cell-handover (a switch of the mobile transmitter from one mobile radio cell to another) or at a black-out of a network.

It should be mentioned, that it is already known to transmit an information signal by means of two or more radio broadcasting transmission paths. In particular, it is referred to U.S. Pat. No. 7,948,933. Here, the transmission is carried out by means of professional devices. Normally, such devices are not directly available. However, a transmission by means of mobile phones is not mentioned.

It also should be mentioned, that a smart phone for reporter purposes is already known from a product of LiveU Inc., the Smartgrip product. This product bears the disadvantage that an additional device is permanently required for connecting the smartphone with a Wi-Fi or a MiFi network.

It also should be mentioned, that a receiver for receiving of the first and the third IP transmission signals and for processing these transmission signals is already known, too. Products of Protonet of Prodys or the product C11 of Mayah are applicable.

Finally, it should be noted that US20120327846 discloses a transmission arrangement provided with two mobile transmitters to transmit an information signal to a receiver. However, both transmitter transmit their transmission signals via the same transmission network. This makes the transmission of the information signal very vulnerable for breakdown of the network. Contrary to this, according to the invention, the first and second transmitters transmit their transmission signals via different transmission networks.

Therefore, breakdown of one of the networks does not harm the transmission of the information signal to the receiver

The objects of the present invention are achieved as described in the attached claims, which are considered an integral part of the present description.

### BRIEF DESCRIPTION OF THE FIGURES

In the following description of the figures, the invention is illustrated in more detail by means of several exemplary embodiments.

It shows:

FIG. 1 a first exemplary embodiment of the transmission arrangement,

FIG. 2 an exemplary embodiment of the information blocks in the transmission signals via the various transmission paths,

FIG. 3 further exemplary embodiments of the transmission signals,

FIG. 4 schematically the set-up of the IP block parts and the UDP block parts of the IP information blocks, and

FIG. 5 an exemplary embodiment of a first transmitter.

### DETAILED DESCRIPTION OF THE FIGURES

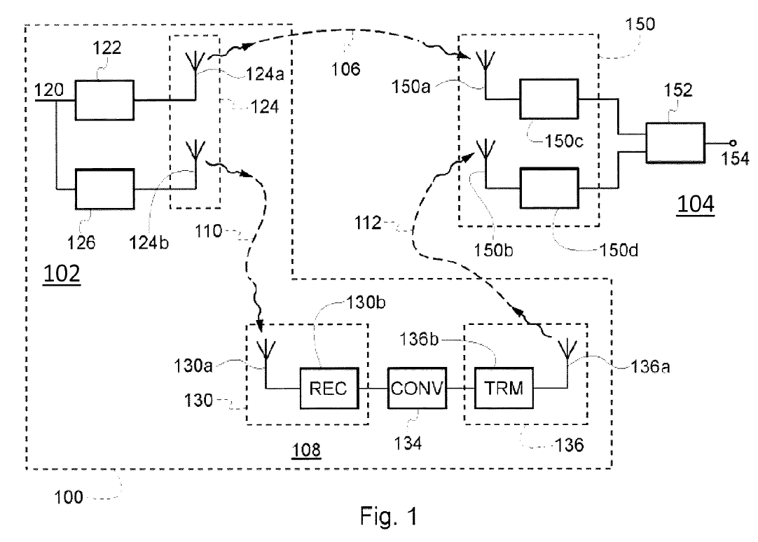

FIG. 1 shows a first exemplary embodiment of the transmission arrangement 100, which is provided with a first and a second mobile transmitter 102 and 108 and a receiver 104. The first mobile transmitter 102 can be formed as a mobile phone or as a tablet. In particular, the first transmitter 102 comprises a smartphone operating system. The first mobile transmitter 102 is adapted to transmit a first information signal, e.g. an audio information signal, to the receiver 104 via a first transmission path 106. The first mobile transmitter 102 is also adapted to convert the first information signal into a second information signal and to transmit the second information signal to a second mobile transmitter 108 via a second transmission path 110. This second mobile transmitter 108 is adapted to receive the second information signal and to transmit the second information signal as an error correction signal to the receiver apparatus 104, via a third transmission path 112.

The first and third transmission paths should run via different transmission networks. This means that, as an example, the first transmission path could run via a 3G transmission network, whilst the third transmission path could run via a 4G transmission network, or vice versa. Or, the first transmission path could run via a first mobile telephone provider, whilst the third transmission path could run via a different mobile telephone provider. Or, the first transmission path could run via a mobile telephone provider and the third transmission path could run via a WLAN hotspot, or vice versa.

The first information signal, e.g. in form of a data compressed audio signal, such as a MP3 (MPEG audio layer 3) encoded or AAC (Advanced Audio Coding) encoded signal, can be applied to the input unit, in this case in form of an input terminal 120, of the transmitter 102. However, it should be mentioned that also other information signals, such as digital video signals, can be applied to the transmitter and can be transmitted to the receiver 104.

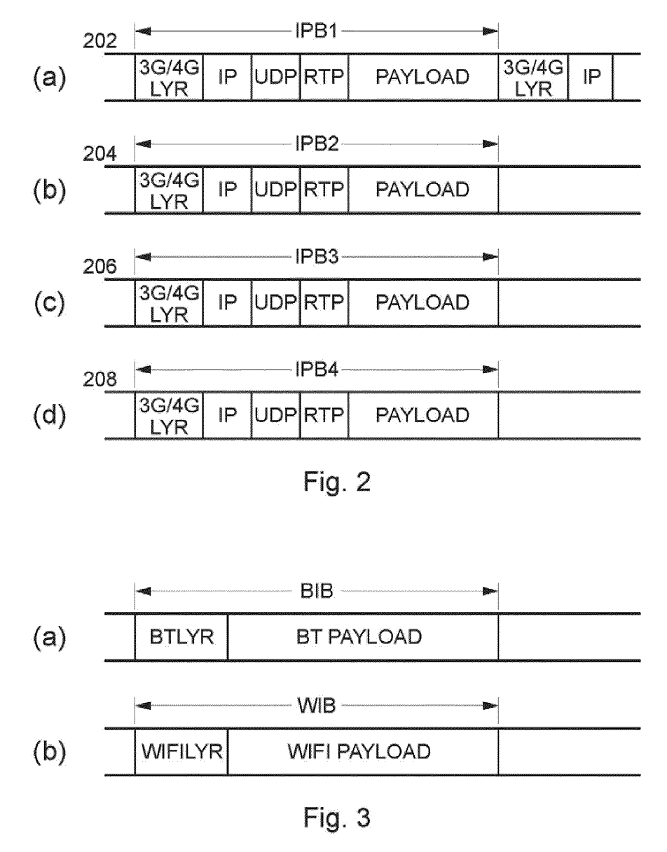

The transmitter 102 contains a converter unit 122 which stores the first information signal provided at the input 120 in subsequent blocks, and which converts the subsequent blocks of the information signal into subsequent IP information blocks. In FIG. 2a, an exemplary embodiment of the IP information signals is shown in form of the IP information block IPB1 in a serial data stream 202. The IP information block IPB1 comprises a block part indicated with Payload, in which a block of the first information signal is stored. By inserting a RTP (Real Time Protocol) header at the beginning, a RTP Payload data stream is generated. By inserting an UDP (Universal Datagram Protocol) header at the beginning, an UDP data stream is generated. By inserting an IP (Internet Protocol) header at the beginning, an IP data stream is generated, which is emitted as first transmission signal by means of a transmission arrangement 124 (the antenna 124a, and, if necessary, the emitting electronics—not shown) via the transmission path 106. The IP headers in the IP information blocks IPB1 in the first transmission signal according to FIG. 2a comprise a first destination IP address which is equal to the IP address of the receiver 104. The UDP headers in the IP information blocks IPB1 in the first transmission signal according to FIG. 2a comprise a first destination UDP port address which is equal to a port address of a port of the receiver 104. In the present exemplary embodiment, the receiver 104 comprises at least two ports.

In addition, depending on the exact type of the first transmission path 106, further headers can be inserted at the beginning, which, in case of a 3G or 4G transmission path, are indicated as 3G layer (3G LYR) or 4G layer (4G LYR) in FIG. 2a.

The first mobile transmitter 102 is further provided with a second converter unit 126. The converter unit 126 is adapted to convert the first information signal provided at the input terminal 120 into a second transmission signal and to transmit the second transmission signal to the second transmitter 108 via the second transmission path 110. The second transmission path is, in general, an IP transmission path, e.g. a WiFi transmission path. The second transmission path 110 can also be, e.g., a BT (Bluetooth) transmission path. If applicable, establishing the communication between the two transmitters 102 and 108 can be facilitated by using a QR code or NFC (Near Field Communication), as will be discussed later.

In the converter unit 126, the first information signal can be converted to an error correction signal, or particularly not converted to an error correction signal. In the latter case, and assuming the second transmission path 110 is also an IP transmission path, the subsequent blocks of the first information signal are converted into subsequent IP information blocks. An exemplary embodiment of the IP information blocks is shown in FIG. 2b by means of the IP information block IPB2 in the serial data stream 204. The IP information block IPB2 comprises a block part, indicated with Payload, in which a block of the first information signal is stored. By inserting a RTP (Real Time Protocol) header at the beginning, a RTP Payload data stream is generated. By inserting an UDP (Universal Datagram Protocol) header at the beginning, an UDP data stream is generated. By inserting an IP (Internet Protocol) header at the beginning, an IP data stream is generated. Further, depending on the exact type of the first transmission path 110, a further header is inserted at the beginning, which, in case of a 3G or 4G transmission path, is indicated as 3G layer (3G LYR) or 4G layer (4G LYR) in FIG. 2b. Thereby, the second transmission signal is generated, which is emitted by means of an antenna arrangement 124 (the antenna 124b, and, if necessary, the emitting electronics—not shown). The IP header in the IP information blocks IPB2 in the second transmission signal according to FIG. 2b comprise a second destination IP address which is equal to the IP address of the transmitter 108. The UDP header in the IP information blocks IPB2 in the second transmission signal according to FIG. 2b comprise a destination UDP port address which is equal to a port address of a second port of the second transmitter 108.

In the exemplary embodiment of the first transmitter 102, two separate antennas 124a and 124b are provided in the antenna arrangement 124. However, this is not required. The two first and second transmission signals can also be emitted by means of a shared antenna, assuming the shared antenna is suitable for emitting the two signals.

In case the audio information in the converter unit 126 is converted into an error correction signal, a second transmission signal is generated, as shown as an example in FIG. 2c. The second transmission signal in FIG. 2c is formed as a serial data stream from IP information blocks IPB3. In the converter unit 126, the blocks of the first information signal are converted into error correction blocks and said error correction blocks are subsequently stored as block parts indicated with Payload in the IP information blocks IPB4. The second transmission signal in FIG. 2c is formed as serial data stream of IP information blocks. In the converter unit 126, the blocks of the first information signal are converted into error correction blocks and said error correction blocks are subsequently stored in the block parts indicated with Payload in the IP information blocks IPB4. An error correction indicator FEC is inserted in front of the block parts indicated with Payload. Subsequently, a RTP header, an UDP header and an IP header are again inserted at the beginning In addition, as also discussed above, a further header is inserted at the beginning, which, in case of a 3G or 4G transmission path, is indicated as 3G layer (3G LYR) or 4G layer (4G LYR) in FIG. 2b. Thereby, the IP information blocks IPB3 of the second transmission signal are generated.

The error correction indicator FEC specifies that and how the first information signal has to be error corrected when received. The conversion in the converter unit 126 can be implemented in different ways. In a first exemplary embodiment, the conversion implies that the first information signal is stored in the IP information blocks IPB3 amended. Thus, the error correction indicator FEC has a determined value.

In a second exemplary embodiment, the conversion in the converter unit 126 implies that a XOR processing step is carried out on subsequent blocks of the first information signal. For example, a XOR processing step is carried out on directly subsequent blocks of the first information signal. Carrying out the XOR processing step on two blocks of the first information signal spaced apart N blocks from each other is also possible. N may be a distinct integer, such as 1, 2, 3, . . . . Depending on the value of N, the error correction indicator in the FEC header hence comprises a different value.

XOR processing steps between information blocks are known per se. Hence, a detailed description is not necessary.

The IP headers in the IP information blocks IPB3 in the second transmission signal according to FIG. 2c comprise, as already described above in similar fashion, a second destination IP address which is equal to the IP address of the transmitter 108. The UDP headers in the IP information blocks IPB4 in the second transmission signal according to FIG. 2c comprise a destination UDP port address which is equal to a port address of the second port of the second transmitter 108.

In another exemplary embodiment of the first transmitter 102, for example, a Bluetooth transmission path with the second transmitter 108 is realized. In this case, the converter unit 126 generates a second transmission signal as shown in FIG. 3a. In a Bluetooth transmission, Bluetooth information blocks BIB are built up as can be seen in FIG. 3a. Thereby, (as an example) a BT Payload block part is inserted before a BT transmission layer indicated with BT LYR in FIG. 3. Hence, the BT Payload block part comprises the information in the Payload Block parts of the information blocks IPB2 and IPB3 respectively, and if an error correction indicator FEC should be transmitted, as in FIG. 2c, the error correction indicator FEC is also transmitted. Furthermore, a destination address is transmitted, which is equal to the destination address of the second transmitter 108 and a port address is transmitted, which is equal to a port address of the second transmitter 108. Or, the first transmitter 102 is adapted to establish a WiFi transmission path with the second transmitter 108. In this case, the converter unit 126 generates a second transmission signal, as shown in FIG. 3b. In a WiFi transmission, WiFi information blocks WIB are built up, as shown in FIG. 3b. Thereby, (as an example) a WiFi Payload block part is inserted before a WiFi transmission layer indicated with WiFi LYR in FIG. 3b. Then, the WiFi block part comprises the information in the Payload bock parts of the information blocks IPB2 and IPB3 respectively, and if an error correction indicator FEC should be transmitted, as shown in FIG. 2c, this error correction indicator is also transmitted. Furthermore, a destination address is transmitted, which is equal to the destination address of the second transmitter 108 and a port address is transmitted, which is equal to a port address of the second transmitter 108.

The second mobile transmitter 108 of the transmission arrangement 100 in FIG. 1 is provided in form of a mobile phone or a tablet. In particular, the second transmitter 108 comprises a smartphone operating system. The transmitter 108 is provided with a receiver unit 130 (the receiver antenna 130a and the receiver electronics REC 130b) for receiving the second transmission signal. Further, the second transmitter is provided with a converter unit 134 for converting the received second transmission signal into the third transmission signal and is provided with an antenna arrangement 136 (the sending antenna 136a and the sending electronics TRM 136b) for transmitting the third transmission signal via the third transmission path 112 to the receiver 104. In all cases, wherein the second mobile transmitter 108 receives the second transmission signal according to FIG. 2b or one of the second transmission signals according to FIG. 2c, 3a or 3b, said transmission signals are converted in the converter unit 134 into a third transmission signal as shown in FIG. 2d. If the second mobile transmitter 108 receives a transmission signal according to FIG. 2b, the converter unit is hence adapted to derive the blocks of the first information signal from the block parts indicated with Payload of the IP information blocks IPB2. Subsequently, the in this way derived first information signal is converted into an error correction signal in the converter unit 134, and the third transmission signal as shown in FIG. 2d is generated. The third transmission signal in FIG. 2d is generated as serial data stream of IP information blocks IPB4. The blocks of the audio information are converted under the influence of the conversion in the converter unit 134 into error correction blocks and, subsequently, the error correction blocks are stored in the block parts indicated with Payload in the IP information blocks IPB4. An error correction indicator FEC is inserted before the block parts indicated with Payload. Subsequently, a RTP header, an UDP header and an IP header are again inserted at the beginning to generate the IP information blocks IPB4 of the third transmission signal.

The error correction indicator FEC states that and how the first information signal is to be error corrected when it is received at the receiver 104. The conversion in the converter unit 134 into an error correction signal can be realized in different ways, as already specified before. In a first exemplary embodiment, the conversion in the converter unit 134 implies that the changed first information signal is stored in the IP information blocks IPB4. The error correction indicator in the FEC header hence has a determined value.

In a second exemplary embodiment, the conversion in the converter unit 134 implies that a XOR processing step is carried out on subsequent blocks of the first information signal.

For example, a XOR processing step is carried out on directly subsequent blocks of the first information signal. Carrying out the XOR processing step on two blocks of the first information signal spaced apart N blocks from each other is also possible. N may be a distinct integer, such as 1, 2, 3, . . . . Depending on the value of N, the error correction indicator in the FEC header hence comprises a different value.

The converter unit 134 is further adapted to convert the second destination IP addresses in the IP headers of the second transmission signal 204 into the first destination IP addresses, which are stored in the IP header of the information blocks IPB4 in the third transmission signal according to FIG. 2d. Said first destination IP addresses are equal to the IP address of the receiver 104. The converter unit 134 is also adapted to convert the destination UDP port addresses in the UDP headers of the second transmission signal 204 into the second UDP port addresses which are stored in the UDP headers of the information blocks IPB4 of the third transmission signal according to FIG. 2d. The second UDP port addresses are equal to the port addresses of a second port of the receiver 104.

In the exemplary embodiment in which the second mobile transmitter 108 receives a transmission signal 301 according to FIG. 2c, the converter unit 134 is adapted to convert the second destination IP addresses in the IP headers of the second transmission signal 301 into the first destination IP addresses which are stored in the IP headers of the information blocks IPB3 in the third transmission signal according to FIG. 2d, because the first information signal is already received as error correction signal. Said first destination IP addresses are equal to the IP address of the receiver 104. The converter unit 134 is also adapted again to convert the destination UDP port addresses in the UDP headers of the second transmission signal 301 into the second UDP port addresses which are stored in the UDP headers of the information blocks IPB4 of the third transmission signal according to FIG. 2d. The second UDP port addresses are equal to the port address of the second port of the receiver 104.

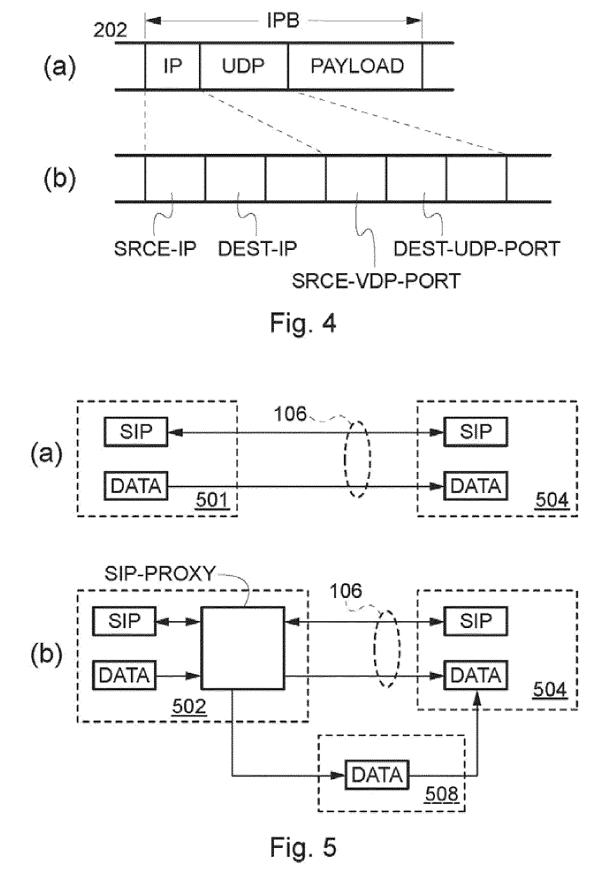

FIG. 4 schematically shows the setup of the IP block parts and the UDP block parts of the IP information blocks. As already discussed above, an IP information block IPB comprises IP block parts and UDP block parts, as indicated with IP and UDP in FIG. 4a. In FIG. 4b, these IP block parts and UDP block parts are shown in a magnified view. The IP block part comprises a source address (SCRE-IP) which defines the transmitter (hence a transmitter IP address of the transmitter) and a receiver address (DEST-IP) which defines the receiver (hence the above mentioned destination IP address). The UDP block part comprises a source port address (SCRE-UDP-PORT) which defines a port in the transmitter (hence a transmitter UDP port address) and a receiver port address (DEST-UDP-PORT) which defines a port in the receiver (hence the above mentioned destination UDP port address).

In another exemplary embodiment in which the second mobile transmitter 108 receives a transmission signal according to FIG. 3a, hence a Bluetooth transmission signal, the converter unit 126 is adapted to derive the information to be transmitted from the BT Payload block parts of the BT transmission blocks. Further, the processing in the mobile transmitter 108 is equal to the processing already discussed above.

In yet another exemplary embodiment in which the second transmitter 108 receivers a transmission signal according to FIG. 3b, hence a WiFi transmission signal, the converter unit 126 is adapted to derive the information to be transmitted from the WiFi Payload block parts of the WiFi transmission blocks. Further, the processing in the mobile transmitter 108 is equal to the processing already discussed above. It should be mentioned that a WiFi connection is also an IP connection.

The operation method of the receiver 104 is discussed in the following. As mentioned above, a receiver suitable for this application is already known per se. The receiver 104 contains a receiving antenna arrangement 150, in this exemplary embodiment with a first receiving antenna 150a for receiving the transmission signal 202 transmitted via the first transmission path 106 and a second receiving antenna 150b for receiving the transmission signal 301 transmitted via the second transmission path 112. Antenna amplifiers 150c and 150d may be provided to amplify the received transmission signals which are fed to a signal processing unit 152. The received transmission signals are decoded in the signal processing unit 152, i.e. the information content as contained in the Payload block parts of the IP information blocks IPB1 (see FIG. 2a) and IPB4 (see FIG. 3a) is derived thereof. The signal processing unit 152 is further suitable to determine if the received transmission signal 202 does not comprise or if it comprises any errors. If it does not comprise any errors, the information content of the Payload block parts of the transmission signal 202 are gathered to an output information signal provided at the output 154.

If errors are detected in the received transmission signal 202, an error correction is carried out in the processing unit 152 by replacing a damaged information block in the transmission signal 202 with an error-free information block of the transmission signal 301 which corresponds to said damaged information block.

If the error correction conversion carried out at the transmission end means nothing else than that the information signal is transmitted amended via the second transmitter 108 to the receiver 104, the error correction on the receiver end means nothing more than replacing an defective or missing information block in the transmission signal 202 with the information block of the transmission signal 301 which corresponds to the defective or missing information block.

If the error correction conversion, as carried out on the sending end, e.g., is realized by means of a linkage of subsequent information blocks, at first, an inverted linkage should be carried out in the receiver to obtain the individual information blocks, wherein, again, a defective or missing information block in the transmission signal 202 can be replaced with the information block of the transmission signal 301 which corresponds to the defective or missing information block.

FIG. 4 shows another exemplary embodiment 502 of the first transmitter, wherein said first transmitter 502 is provided with a SIP (Session Initiation Protocol) Proxy unit, see FIG. 5b. The Session Initiation Protocol is a transmission protocol for setting up, controlling and terminating a communication connection between two and more participants. The protocol is, inter alia, specified in RFC3261. In IP transmission networks (IP telephone communication), SIP is a frequently used protocol. FIG. 5a shows the interaction between a transmitter 501 and a receiver 504 according to prior art. Said interaction is controlled via the two SIP units in the devices 501 and 504, whereby information data, indicated with DATA in FIG. 5a, can be transmitted from the transmitter 501 to the receiver 504. The transmitter 501 in FIG. 5a corresponds to the mobile transmitter 102 regarding the Elements 122 and 124a. The receiver 504 in FIG. 5a corresponds to the receiver 104 in FIG. 1. The SIP controlling and the data are transmitted between the transmitter 501 and the receiver 504 via two virtual lines via the transmission path 106 (also see FIG. 1).

The functioning according to the invention can be realized within a SIP Proxy unit (app) which thus may be installed in the first transmitter 102. A setup as shown by means of the transmitter 502 in FIG. 5b is generated by loading the SIP Proxy unit 510 in the transmitter 501. The SIP Proxy unit 510 is provided at the output line of the transmitter 501, whereby the setup as shown in FIG. 5b is established. The SIP Proxy unit 510 also provides the setup of the second transmission path 110 with the second transmitter 508 in addition to the already existing transmission path 106 to the receiver 504, and whereby the signal processing for obtaining the transmission signal for the second transmitter 508 is also established.

Since the SIP protocol in general supports an error correction, an error protection can be added to the signalling without the necessity of the transmitter application in the first transmitter 102/502 to support the error correction itself. The RTP communication is hence lopped in and diverted by the SIP Proxy unit 510 and transmitted to the second transmitter 108/508 as an error corrected transmission signal (assuming the error correction is already carried out in the first transmitter 102/502).

As already mentioned above, the first information signal may, e.g., be a data compressed audio signal, such as a MP3 (MPEG audio layer 3) encoded or AAC (Advanced Audio Coding) encoded signal. It was mentioned furthermore, that also other information signals, such as digital video signals, can be provided to the first transmitter and transmitted to the receiver 104. Because video signals in general comprise a big data volume, the data transmission paths 110 and 112 (see FIG. 1) shall each be realized by means of multiple parallel transmission paths. Thus, also multiple mobile transmitters (than just the transmitter 108) may be required for realizing the transmission of the first transmission signals.

In the following, establishing the transmission path 110 between the first transmitter 102 and the second transmitter 108 by means of an initiation step via NFC or QR code is discussed. Furthermore, information is transmitted from the first transmitter 102 to the second transmitter 108 by means of said initiation step, in order that the third transmission path 112 between the second transmitter 108 and the receiver 104 can be established. The first transmission path 106 is established by a call from the first transmitter 102 to the receiver 104, including a request to the receiver 104 to send a (first) destination IP address and a first and second UDP port address of said receiver. An initiation step is started by holding the first and the second transmitter close to each other, whereby information is transmitted between the two transmitters 102 and 108 by means of NFC (Near Field Communication). The information e.g. contains
the (second) destination address and port address of the second transmitter 108, which are transmitted from the second transmitter 108 to the first transmitter 102, and
the first destination IP address and second UDP port address of the receiver 104, which are transmitted from the first transmitter 102 to the second transmitter 108.

Thus, for the first transmitter 102 it is possible to establish the first transmission path 106 to the receiver 104 and the second transmission path 110 to the second transmitter 108, whereby the second transmitter 108 is capable to establish the third transmission path 112 with the receiver 104.

In another exemplary embodiment, instead of using NFC, the initiation step can be started by creating a QR code on a screen of the first transmitter 102, which is read by the second transmitter 108. Thus, the information mentioned above can be exchanged between the two transmitters for establishing the two transmission paths 110 and 112.

It should be mentioned that first calling the receiver 104 with the transmitter 102 for transmitting the destination address and the two port addresses is not essential. This may also take place later, namely after the initiation step. Thus, the destination address and the second port address have to be transmitted later.

Further implementation details will not be described, as the man skilled in the art is able to carry out the invention starting from the teaching of the above description.

1. A transmission arrangement provided with a mobile transmitter, for transmitting an information signal, e.g. an audio information signal, to a receiver, the mobile transmitter being adapted to store subsequent blocks of information of the information signal in subsequent IP (Internet Protocol) information blocks (IPB) and to transmit the IP information blocks as a first transmission signal via a first transmission path to the receiver, wherein the transmission arrangement is further provided with at least a second mobile transmitter, that the first mobile transmitter is further adapted to transmit a second information signal derived from the first mentioned information signal, in subsequent information blocks as a second transmission signal via a second transmission path to at least the second mobile transmitter, that at least the second transmitter is adapted to receive the second transmission signal from the first mobile transmitter, to derive an error correction signal from the second transmission signal and to transmit the error correction signal in IP information blocks as a third transmission signal via a third transmission path to the receiver, the first and third transmission path running via different transmission networks, and, that at least the second mobile transmitter comprises a smartphone operating system.

2. The transmission arrangement as claimed in claim 1, wherein the first mobile transmitter is adapted to transmit the first information signal via the second transmission path to the second mobile transmitter, and that the second mobile transmitter is adapted to receive the first information signal from the second transmission path , to convert the first information signal in the error correction signal and is adapted to store subsequent blocks of the error correction signal in the IP information blocks of the third transmission signal.

3. The transmission arrangement as claimed in claim 1, wherein the first mobile transmitter is adapted to convert the first information signal in the error correction signal and is adapted to store subsequent blocks of the error correction signal in information blocks of the second transmission signal, and to transmit the second information signal via the second transmission path to the second mobile transmitter, and that the second mobile transmitter is adapted to receive the error correction signal from the second transmission path and to convert the second transmission signal into the third transmission signal.

4. The transmission arrangement as claimed in claim 1, wherein the first mobile transmitter comprises a smartphone operating system.

5. The transmission arrangement as claimed in claim 1, wherein the error correction signal equals the first information signal transmitted via the first transmission path.

6. The transmission arrangement as claimed in claim 1, wherein the error correction signal is derived from an XOR processing step carried out on the first information signal.

7. The transmission arrangement as claimed in claim 6, wherein an XOR processing step is carried out successive blocks of the first information signal to derive the error correction signal.

8. The transmission arrangement as claimed in claim 1, wherein the IP information blocks which are transmitted via the first and third transmission paths all include the same first Destination IP address, which first destination IP address is the destination IP address of the receiver, and the information blocks transmitted via the second transmission path include a second destination address, which second destination address is the destination address of the second transmitter.

9. The transmission arrangement as claimed in claim 1, wherein the IP information blocks transmitted via the first transmission path include a first UDP port address, the IP information blocks transmitted via the third transmission path include a second UDP port address, which first and second UDP port addresses equal the port addresses of a first and second port, respectively, of the receiver, the information blocks of the second information signal include a third port address, which third port address is the port address of a port of the second transmitter.

10. The transmission arrangement as claimed in claim 1, wherein the first, second and third transmission paths are mobile phone transmission paths.

11. The transmission arrangement as claimed in claim 1, wherein a transmission path is a mobile phone transmission path and another transmission path is a Bluetooth or a WLAN transmission path.

12.-29. (canceled)

30. The transmission arrangement as claimed in claim 1, wherein for realizing the second transmission path between the first and second transmitter, an initiation step is carried out using NFC or a QR code.
